(19) United States
(12) Patent Application Publication
(10) Pub. No.: US 2024/0413857 A1
(43) Pub. Date: Dec. 12, 2024

(54) METHOD AND APPARATUS FOR CONTROLLING MULTIPLE RECONFIGURABLE INTELLIGENT SURFACES

(71) Applicant: ELECTRONICS AND TELECOMMUNICATIONS RESEARCH INSTITUTE, Daejeon (KR)

(72) Inventors: Jun Hyeong KIM, Daejeon (KR); Seon Ae KIM, Daejeon (KR); IL GYU KIM, Daejeon (KR); Hee Sang CHUNG, Daejeon (KR); Sung Woo CHOI, Daejeon (KR)

(73) Assignee: ELECTRONICS AND TELECOMMUNICATIONS RESEARCH INSTITUTE, Daejeon (KR)

(21) Appl. No.: 18/738,637

(22) Filed: Jun. 10, 2024

(30) Foreign Application Priority Data
Jun. 9, 2023 (KR) 10-2023-0074347
Nov. 24, 2023 (KR) 10-2023-0166046

(51) Int. Cl. H04B 7/04; H04B 7/06; H04W 72/20

(52) U.S. Cl. CPC H04B 7/04013; H04B 7/0696; H04W 72/20

(57) ABSTRACT

A method of a reconfigurable intelligent surface (RIS) node may comprise: receiving, from a first transmitting node, control information for controlling the first RIS node; grouping reflecting elements of the first RIS node into at least one reflecting element group using the control information; and transmitting at least one signal incident on the at least one reflecting element group to a receiving node.

### CROSS-REFERENCE TO RELATED APPLICATIONS

This application claims priority to Korean Patent Applications No. 10-2023-0074347, filed on Jun. 9, 2023, and No. 10-2023-0166046, filed on Nov. 24, 2023, with the Korean Intellectual Property Office (KIPO), the entire contents of which are hereby incorporated by reference.

### BACKGROUND

### 1. Technical Field

The present disclosure relates to a reconfigurable intelligent surface, and more particularly, to a method for controlling multiple reconfigurable intelligent surfaces.

### 2. Related Art

A reconfigurable intelligent surface (RIS) can artificially reconfigure a propagation environment of electromagnetic waves to enhance spectral and energy efficiency of wireless networks. As a new hardware technology, the RIS can be a candidate technology for 5G-Advanced and 6G. The RIS is also referred to as an intelligent reconfigurable surface (IRS).

The RIS may include RIS reflecting elements. The RIS may adjust phases of the RIS reflecting elements. By adjusting the phases of the reflecting elements, the RIS can transmit reflected signals to a terminal. The terminal can combine the reflected signals transmitted by the RIS and direct-path signals transmitted by a base station to improve received signal strengths. Additionally, the terminal can combine the reflected signals transmitted by the RIS and the direct-path signals transmitted by the base station to mitigate signal interference. In the case of 5G/6G communication systems using high-frequency bands such as millimeter-wave (mmWave) band, there may be issues with the direct-path signals being blocked by obstacles.

### SUMMARY

The present disclosure for resolving the above-described problems is directed to providing a method and an apparatus for controlling multiple reconfigurable intelligent surfaces.

A method of a reconfigurable intelligent surface, according to a first exemplary embodiment of the present disclosure for achieving the above-described objective, may comprise: receiving, from a first transmitting node, control information for controlling the first RIS node; grouping reflecting elements of the first RIS node into at least one reflecting element group using the control information; and transmitting at least one signal incident on the at least one reflecting element group to a receiving node.

The receiving of the control information for controlling the first RIS node may comprise: receiving the control information from a first node receiving the control information from the first transmitting node, wherein the first node includes at least one of a fixed network node or a mobile network node.

The grouping of the reflecting elements of the first RIS node may comprise: grouping the reflecting elements of the first RIS node into reflecting element groups sharing at least one reflecting element of the first RIS node.

The transmitting of the at least one signal may comprise: transmitting the at least one signal to the receiving node by performing at least one of reflection, pass-through, or suppression in at least one direction.

The transmitting of the at least one signal may comprise: receiving signals having different directions; and transmitting the signals to the receiving node by outputting the signals as at least one of a reflection beam set, a pass-through beam set, or a suppression beam set, wherein the reflection beam set may include at least one reflected beam, the pass-through beam set may include at least one beam passed through the at least one RIS node, and the suppression beam set may include at least one beam generated by blocking or suppressing reflection or pass-through of at least portion of the at least one signal.

A method of a base station, according to a second exemplary embodiment of the present disclosure for achieving the above-described objective, may comprise: receiving, from a receiving node, feedback information including channel state information; determining at least one reconfigurable intelligent surface (RIS) node allocated to the receiving node, based on the channel state information included in the feedback information; generating grouping information indicating to group reflecting elements of the at least one RIS node into at least one reflecting element group, based on the channel state information included in the feedback information; generating control information including at least one of the grouping information or information for configuring the at least one RIS node; and controlling the at least one RIS node by transmitting the control information.

The determining of the at least one RIS node may comprise: determining the at least one RIS node allocated to the receiving node based on whether an angle between a surface of the at least one RIS node and a signal received by the receiving node is less than a threshold.

The determining of the at least one RIS node may comprise: determining the at least one RIS node allocated to the receiving node based on whether at least one of a frequency shift or spreading value between the at least one RIS node and the receiving node is less than a threshold.

The determining of the at least one RIS node may comprise: determining the at least one RIS node allocated to the receiving node based on whether a quality of a signal received by the receiving node is less than a threshold.

The control information may include information for applying at least one of reflection, pass-through, or suppression to a signal incident on the at least one RIS node in at least one direction.

The control information may include: at least one of information on an RIS node set used for configuring the at least one RIS node, output mode information of the at least one RIS node, information on a transmittance of the at least one RIS node, information on a reflectance of the at least one RIS node, state information of the at least one RIS node, state information of each reflecting element of the at least one RIS node, information on a set of reception beams incident on the at least one RIS node, or information on a set of output beams output by the at least one RIS node, and the output mode information of the at least one RIS node may include: at least one of pass-through mode information, reflection mode information, suppression mode information, and simultaneous mode information, and the information on the set of reception beams includes at least one of information on a set of reception directions for an incident signal or information on a set of angles of the incident signal, and the information on the set of output beams includes at least one of information on a set of output directions or information on a set of output angles.

The information on the set of output beams may include information on at least one output beam set associated with at least one signal among incident signals, and output beam sets associated with different incident signals included in the incident signals may be different from or same as each other.

A reconfigurable intelligent surface node, according to a third exemplary embodiment of the present disclosure for achieving the above-described objective, may comprise at least one processor, and the at least one processor may cause the first RIS node to perform: receiving, from a first transmitting node, control information for controlling the first RIS node; grouping reflecting elements of the first RIS node into at least one reflecting element group using the control information; and transmitting at least one signal incident on the at least one reflecting element group to a receiving node.

In the receiving of the control information for controlling the first RIS node, the at least one processor may further cause the first RIS node to perform: receiving the control information from a first node receiving the control information from the first transmitting node, wherein the first node may include at least one of a fixed network node or a mobile network node.

In the grouping of the reflecting elements of the first RIS node, the at least one processor may further cause the first RIS node to perform: grouping the reflecting elements of the first RIS node into reflecting element groups sharing at least one reflecting element of the first RIS node.

In the transmitting of the at least one signal, the at least one processor may further cause the first RIS node to perform: transmitting the at least one signal to the receiving node by performing at least one of reflection, pass-through, or suppression in at least one direction.

In the transmitting of the at least one signal, the at least one processor may further cause the first RIS node to perform: receiving signals having different directions; and transmitting the signals to the receiving node by outputting the signals as at least one of a reflection beam set, a pass-through beam set, or a suppression beam set, and wherein the reflection beam set may include at least one reflected beam, the pass-through beam set may include at least one beam passed through the at least one RIS node, and the suppression beam set may include at least one beam generated by blocking or suppressing reflection or pass-through of at least portion of the at least one signal.

According to the present disclosure, the terminal can combine the reflected signals transmitted by the RIS and the direct-path signals transmitted by the base station to solve the problem of signal blockage caused by obstacles. Furthermore, the terminal can combine the reflected signals transmitted by the RIS and the direct-path signals transmitted by the base station to improve received signal strengths. In addition, the terminal can combine the reflected signals transmitted by the RIS and the direct-path signals transmitted by the base station to mitigate signal interference.

According to the present disclosure, the communication method based on multiple mobile RISs can effectively control the mobile RISs within a mobile RIS-based wireless communication network. The communication method based on multiple mobile RISs can be similarly applied in various mobile communication environments, including buses, general passenger cars, aircrafts, ships, and others.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a conceptual diagram illustrating an exemplary embodiment of an NCR-based relay.

FIG. 4 is a conceptual diagram illustrating exemplary embodiments of a reconfigurable intelligent surface (RIS)-based relay.

FIG. 5 is a conceptual diagram illustrating an exemplary embodiment of a wireless communication system supporting RIS.

FIG. 6 is a conceptual diagram illustrating exemplary embodiments of a multi-RIS-based mobile communication network.

FIG. 7 is a conceptual diagram illustrating exemplary embodiments of a multi-RIS-based mobile communication network.

FIG. 8 is a conceptual diagram illustrating exemplary embodiments of a multi-RIS-based communication method.

FIG. 9 is a conceptual diagram illustrating an exemplary embodiment of an RIS control information transmission method.

FIG. 10 is a conceptual diagram illustrating an exemplary embodiment of an RIS control information transmission method.

FIG. 11 is a conceptual diagram illustrating an exemplary embodiment of beam sets for an RIS node.

FIG. 12 is a conceptual diagram illustrating an exemplary embodiment of beam sets for an RIS node.

FIG. 13 is a conceptual diagram illustrating an exemplary embodiment of beam sets for an RIS node.

FIG. 14 is a conceptual diagram illustrating an exemplary embodiment of beam correspondence for an RIS node.

FIG. 15 is a conceptual diagram illustrating exemplary embodiments of connections between RIS nodes and base station.

FIG. 16 is a conceptual diagram illustrating exemplary embodiments of connections between RIS nodes and base station.

FIG. 17 is a conceptual diagram illustrating exemplary embodiments of connections between RIS nodes and base station.

FIG. 18 is a conceptual diagram illustrating exemplary embodiments of connections between RIS nodes and base station.

FIG. 19 is a conceptual diagram illustrating exemplary embodiments of connections between RIS nodes and base station.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present disclosure, ‘(re) transmission’ may refer to ‘transmission’, ‘retransmission’, or ‘transmission and retransmission’, ‘(re) configuration’ may refer to ‘configuration’, ‘reconfiguration’, or ‘configuration and reconfiguration’, ‘(re) connection’ may refer to ‘connection’, ‘reconnection’, or ‘connection and reconnection’, and ‘(re) access’ may refer to ‘access’, ‘re-access’, or ‘access and re-access’.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted. The operations according to the exemplary embodiments described explicitly in the present disclosure, as well as combinations of the exemplary embodiments, extensions of the exemplary embodiments, and/or variations of the exemplary embodiments, may be performed. Some operations may be omitted, and a sequence of operations may be altered.

Even when a method (e.g. transmission or reception of a signal) to be performed at a first communication node among communication nodes is described in exemplary embodiments, a corresponding second communication node may perform a method (e.g. reception or transmission of the signal) corresponding to the method performed at the first communication node. That is, when an operation of a user equipment (UE) is described, a base station corresponding thereto may perform an operation corresponding to the operation of the UE. Conversely, when an operation of a base station is described, a corresponding UE may perform an operation corresponding to the operation of the base station. In a non-terrestrial network (NTN) (e.g. payload-based NTN), an operation of a base station may refer to an operation of a satellite, and an operation of the satellite may refer to an operation of the base station.

The base station may be referred to by various terms such as NodeB, evolved NodeB, next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and the like. The user equipment (UE) may be referred to by various terms such as terminal, device, apparatus, node, communication node, end node, access terminal, mobile terminal, station, subscriber station, mobile station, portable subscriber station, on-board unit (OBU), and the like. In the present disclosure, signaling may be one or a combination of two or more of higher-layer signaling, MAC signaling, and physical-layer (PHY) signaling. A message used for higher layer signaling may be referred to as a ‘higher layer message’ or ‘higher layer signaling message’. A message used for MAC signaling may be referred to as a ‘MAC message’ or ‘MAC signaling message’. A message used for PHY signaling may be referred to as a ‘PHY message’ or ‘PHY signaling message’. The higher layer signaling may refer to an operation of transmitting and receiving system information (e.g. master information block (MIB), system information block (SIB)) and/or an RRC message. The MAC signaling may refer to an operation of transmitting and receiving a MAC control element (CE). The PHY signaling may refer to an operation of transmitting and receiving control information (e.g. downlink control information (DCI), uplink control information (UCI), or sidelink control information (SCI)).

In the present disclosure, ‘configuration of an operation (e.g. transmission operation)’ may refer to signaling of configuration information (e.g. information elements, parameters) required for the operation and/or information indicating to perform the operation. ‘configuration of information elements (e.g. parameters)’ may refer to signaling of the information elements. In the present disclosure, ‘signal and/or channel’ may refer to signal, channel, or both signal and channel, and ‘signal’ may be used to mean ‘signal and/or channel’.

A communication system may include at least one of a terrestrial network, non-terrestrial network, 4G communication network (e.g. long-term evolution (LTE) communication network), 5G communication network (e.g. new radio (NR) communication network), or 6G communication network. Each of the 4G communications network, 5G communications network, and 6G communications network may include a terrestrial network and/or a non-terrestrial network. The non-terrestrial network may operate based on at least one communication technology among the LTE communication technology, 5G communication technology, or 6G communication technology. The non-terrestrial network may provide communication services in various frequency bands.

A communication network to which exemplary embodiments are applied is not limited to that described below, and the exemplary embodiments may be applied to various communication networks (e.g. 4G communication networks, 5G communication networks, and/or 6G communication networks). Here, ‘communication network’ may be used interchangeably with a term ‘communication system’.

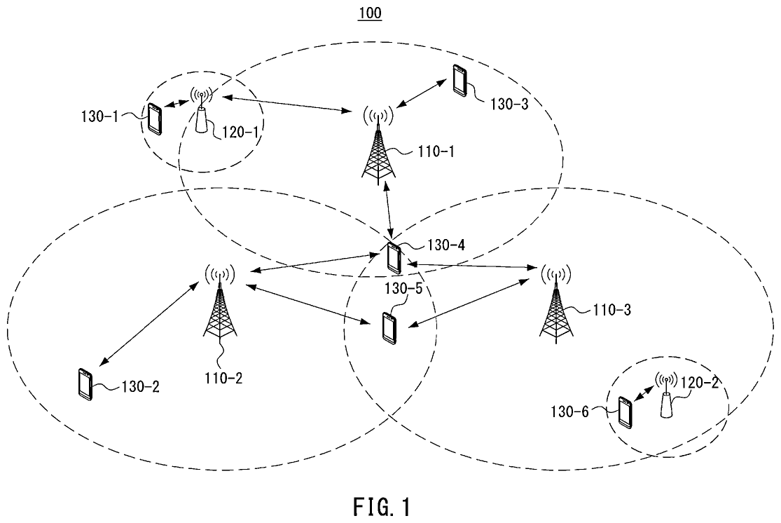

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4G communication (e.g. long term evolution (LTE), LTE-advanced (LTE-A)), 5G communication (e.g. new radio (NR)), etc. specified in the 3rd generation partnership project (3GPP) standards. The 4G communication may be performed in frequency bands below 6 GHZ, and the 5G communication may be performed in frequency bands above 6 GHz as well as frequency bands below 6 GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, or the like.

Further, the communication system 100 may further include a core network. When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

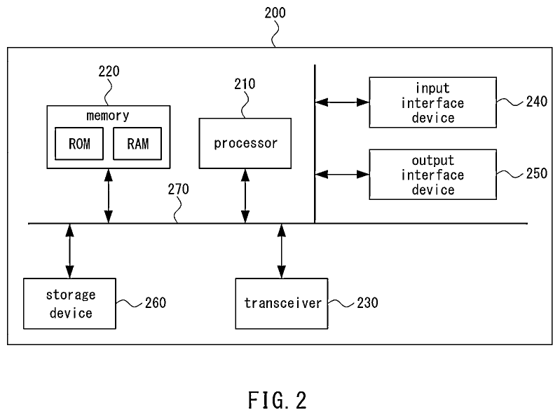

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), base transceiver station (BTS), radio base station, radio transceiver, access point, access node, road side unit (RSU), radio remote head (RRH), transmission point (TP), transmission and reception point (TRP), eNB, gNB, or the like.

Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of Thing (IoT) device, mounted module/device/terminal, on-board device/terminal, or the like.

To secure reliable coverage in cellular communication, mobile communication operators can use various types of network nodes. As a method for securing reliable coverage, a method of deploying full-stack base stations to expand coverage and prevent coverage holes may be used. The method of adding full-stack base stations may be uneconomical in terms of costs. In addition, it may be difficult to deploy the full-stack base stations if there is no wired backhaul. As a method for securing reliable coverage, a method of installing network nodes such as integrated access and backhaul (IAB) nodes and radio frequency (RF) repeaters may be used. The method of installing network nodes such as IAB nodes and RF repeaters can improve network deployment flexibility. The IAB node may be a network node that does not require wired backhaul. The RF repeater may perform amplify-and-forward (AF) operations of amplifying and forwarding received signals. The RF repeater may be used to supplement the coverage of the full-stack base stations.

As a method for securing reliable coverage, a method of using network-controlled repeaters (NCRs) may be used. The NCR may refer to a repeater with improved performance compared to an RF repeater that transmits signals using the AF scheme. An NR NCR is able to receive control information from the network and is able to process the control information received from the network. The NR NCR can perform AF operations more efficiently than the conventional RF repeater. The NR NCR can alleviate unnecessary noise amplification. The NR NCR can transmit and receive signals through beamforming in a specific direction. The NR NCR can perform network integration simplification procedures. A relay communication method using the NR NCR may be as follows.

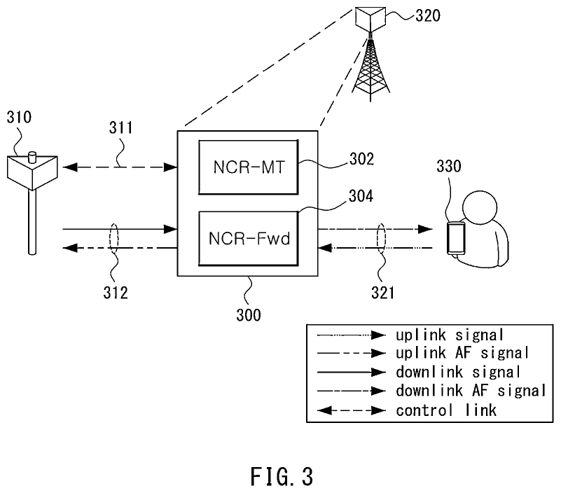

FIG. 3 is a conceptual diagram illustrating an exemplary embodiment of an NCR-based relay.

Referring to FIG. 3, a communication network using an NCR may include at least one of a base station, NCR, or terminal. The NCR may include at least one of an NCR-mobile-termination (NCR-MT) or NCR-forwarding (NCR-Fwd). The NCR-MT may communicate with the base station through a control link based on an NR Uu interface. The NCR-MT and the base station may exchange control information (e.g. control information for controlling the NCR-Fwd). The NCR-Fwd may perform AF operations on uplink/downlink (UL/DL) RF signals according to the control information received from the base station.

The NCR may be different from the existing RF repeater that radiates radio waves in an omni-direction. The NCR may perform a function of an in-band repeater. The function of the in-band repeater may include a function of transmitting a beam in a specific direction according to control information received from the base station through the control link. The NCR may receive the control information from the base station through the control link. The NCR may transmit signals received from the base station in a specific direction to a specific user based on the control information transmitted by the base station.

If an NR NCR exists in the network environment, a base station 310 may be connected to an NCR 320 through a control link 311. In other words, the base station may be connected to an NCR-MT 302 through the control link. The base station may perform various side control information (SCI) signaling and NCR management methods required to control the NCR. The base station 310 may be connected to the NRC 320 through a backhaul link. In other words, the base station may be connected to an NCR-Fwd 304 through a backhaul link 312. The base station may transmit downlink signals to the NCR.

The base station may define signaling and signaling-related operations of SCI (e.g. beamforming, UL-DL TDD operation, ON-OFF information) for controlling the NCR-Fwd. The base station may define control plane signaling and related procedures. The base station may define NCR management solutions (identification and authorization/verification of the NCR). When necessary, the base station may define the NCR-MT's radio resource management (RRM) requirements. The base station may define the NCR's RF and electro-mechanical component (EMC) requirements, if necessary.

The NCR 320 may be an in-band RF repeater used to expand network coverage of the FR1 and FR2 bands based on the NCR model. The NCR may include a single hop fixed NCR 300. The NCR 320 may simultaneously maintain a link between the base station and NCR and a link between the NCR and terminal. The NCR may be connected to a terminal 330 through an access link. In other words, the NCR-Fwd may be connected to the terminal through the access link.

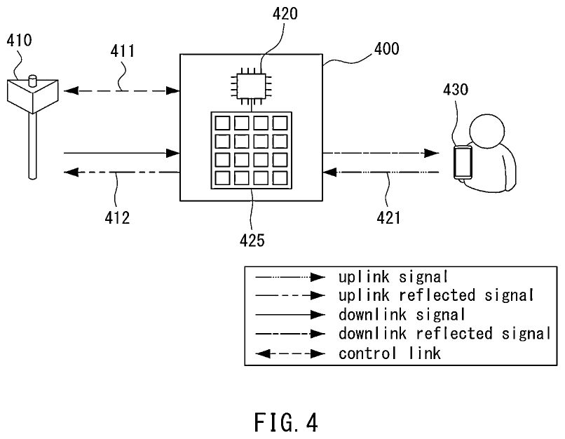

The base station and NCR may transmit and receive signals through the backhaul link 312. The NCR 320 may receive a downlink signal transmitted by the base station. The NCR and the terminal may transmit and receive signals through the access link 321. The NCR may transmit downlink amplified and forwarded (AF) signals to the terminal using the downlink signal transmitted by the base station. The terminal may transmit uplink signals through the access link 321. The NCR may receive uplink signals transmitted by the terminal. The NCR may transmit uplink AF signals to the base station using the uplink signal transmitted by the terminal. The NCR-based relay may be similar to an RIS-based relay. The RIS-based relay may be as shown in FIG. 4 below.

FIG. 4 is a conceptual diagram illustrating exemplary embodiments of a reconfigurable intelligent surface (RIS)-based relay.

Referring to FIG. 4, a reconfigurable intelligent surface may be referred to as RIS. The reconfigurable intelligent surface may be referred to as an intelligent reflective surface (IRS). The IRS may refer to a surface used in a communications system to reflect and/or transmit signals. Among communication nodes, a method performed by a first communication node (or transmitting node) may include a method of transmitting or receiving a signal. The first communication node may include a base station. The first transmitting node may include a base station. A method performed by a second communication node (or receiving node) corresponding to the first communication node may include a method (e.g. reception or transmission of a signal) corresponding to the method performed by the first communication node. The second communication node may include a terminal. The receiving node may include a terminal. A method performed by the second communication node (or receiving node) may correspond to a method performed by the first communication node and may include a method of receiving or transmitting a signal. That is, when an operation of the terminal is performed, a base station corresponding to the terminal may perform an operation corresponding to the operation of the terminal. Conversely, when an operation of the base station is performed, the terminal corresponding to the base station may perform an operation corresponding to the operation of the base station.

The RIS can improve a spectrum and energy efficiency of a wireless network by artificially reconfiguring a propagation environment of electromagnetic waves. The RIS may be a new hardware technology and may be a candidate technology for 5G-Advanced and 6G.

An RIS node 400 may include at least one of an RIS controller 420 or an RIS 425. The RIS may include at least one RIS reflecting element. The RIS node may control phases of the at least one RIS reflecting element. The RIS node may transmit reflected signals to the terminal by adjusting the phases of the at least one reflecting element. The terminal can improve a received signal strength by combining reflected signals transmitted by the RIS and direct-path signals transmitted by the base station. The terminal can alleviate signal interference by combining the reflected signals transmitted by the RIS and the direct-path signals transmitted by the base station. In case of 5G/6G communication systems using high frequency bands such as millimeter-wave (mmWave), direct-path signals may be blocked by obstacles. If direct-path signals are blocked by an obstacle, the terminal may maintain communication by receiving the reflected signals.

An RIS-based relay may be controlled by the base station 410 through a control link, similar to the NCR. The RIS-based relay may adjust values of RIS reflecting elements by control of the base station. The RIS may reflect DL or UL signals incident on the RIS to the base station or terminal. A control link 411 between the base station and the RIS controller 420 may include the same wireless control link as the NCR. The control link 411, unlike the NCR relay, may be efficient in terms of cost and power. The control link 411 may include a wired control link that does not require a separate reception module. The RIS may be connected by wire to a fixed relay installed around the base station or a mobile relay within a coverage of the base station. The base station 410 may transmit control information to the fixed/mobile relay through a wireless link. The fixed/mobile relay may control the RIS 425 according to the control information received from the base station.

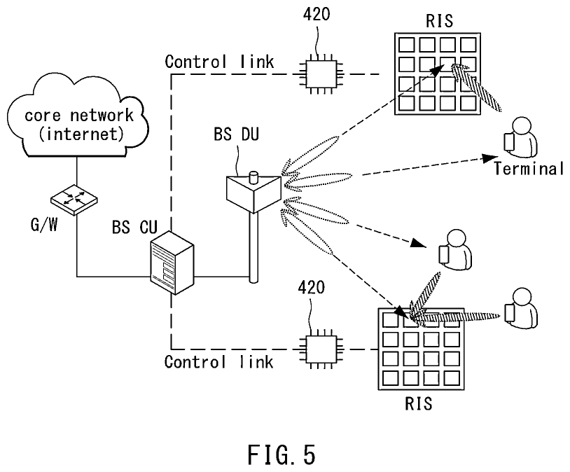

The base station 410 may transmit and receive information with the RIS controller 420 through the control link 411. The base station 410 may transmit downlink signals to the RIS 425. The RIS 425 may receive the downlink signals transmitted by the base station. The RIS 425 may reflect the downlink signals transmitted by the base station. The RIS 425 may transmit the reflected downlink signals to the terminal 430. The terminal 430 may transmit uplink signals 421 to the RIS. The RIS 425 may receive the uplink signals transmitted by the terminal. The RIS 425 may reflect the uplink signals transmitted by the terminal. The RIS 425 may transmit the reflected uplink signals 412 to the base station 410. The RIS-based communication system may be illustrated as shown in FIG. 5.

FIG. 5 is a conceptual diagram illustrating an exemplary embodiment of a wireless communication system supporting RIS.

Referring to FIG. 5, a wireless communication system supporting RIS may include at least one of a core network, gateway (G/W), base station (BS), RIS node, terminal, and the like. The base station may include a base station CU (BS CU) and a base station DU (BS DU). The RIS node may include an RIS controller 420 and an RIS.

The base station may be connected to the RIS node by wire. The base station may be wirelessly connected to the RIS node. In other words, the base station may be connected to the RIS node through the control link (C-link).

The RIS node may receive control information from a C-node. The RIS nod may collect feedback information from network node(s). The network node may include at least one of the base station or terminal. The C-node may refer to the base station. The RIS node may control the RIS node connected to the C-node by considering the control information and feedback information.

The RIS node may adjust phases of reflecting elements by the base station. In other words, the RIS node may adjust the phases of reflecting elements through a control signal (e.g. control information) transmitted by the base station. The RIS node may reflect signals incident on the RIS to the base station or terminal. The incident signals may include DL signals and/or UL signals. The RIS may not perform signal processing procedures on the incident signals. The RIS may perform a role of reflecting signals by adjusting the phases of reflecting elements.

The RIS may have the following advantages over the conventional relays. The RIS can be easily installed. Due to passive characteristics of reflecting elements, the RIS can be manufactured with light weight and thin thickness. The RIS can be installed on various objects such as building surfaces, ceilings, signs, and street lights.

The RIS can be cost-effective. The RIS can be efficient in terms of power. The RIS may not require an analog-to-digital/digital-to-analog converter (AD/DAC) or a power amplifier. The RIS can operate at lower costs in terms of hardware and power consumption compared to the conventional relays.

The RIS can support a full-duplex (FD) mode. The RIS can reflect electromagnetic waves. The RIS does not generate self-interference or thermal noise and can support FD transmission. The RIS can have lower signal processing complexity than FD relays which require their own interference cancellation capability. The RIS can achieve higher spectral efficiency than half-duplex (HD) relays.

A power gain of the RIS can be improved according to a quadratic scaling law rather than a linear power scaling law of an active antenna array.

The RIS may be used in a variety of communication networks due to its advantages. For example, mmWave communication networks may utilize the RIS. mmWave communications can have a high throughput using a wide bandwidth. The mmWave communication networks may experience signal blocking problems due to path losses and obstacles that occur in high frequency bands such as mm Wave bands. The path losses can be mitigated by deploying multiple antenna arrays using short wavelengths of mm Wave in a small space. In other words, path losses can be mitigated through a high antenna gain achieved through mmWave-enabled antenna arrays. Signal blocking due to obstacles can be alleviated through the RIS. The RIS may be located between a transmitter and a receiver, and the RIS can transmit and receive signals through an auxiliary link established between the transmitter and receiver. If a direct link is blocked by an obstacle, the terminal and base station can continue communication through the auxiliary link.

The RIS node may receive separate control signals or transmit channel state information to maintain efficient advantages in terms of cost and power. The RIS node may not have a separate wireless transceiver for transmitting and receiving signals. The RIS node can transmit channel state information to the base station through a wired control link (e.g. C-link) connected to the base station. The RIS node can adjust the phases of the reflecting elements using control information transmitted by the base station.

The base station may transmit control information to the RIS node through the control link. In other words, the base station CU may transmit the control information to the RIS controller through the control link. The RIS controller may receive the control information transmitted by the base station CU. The RIS controller can adjust the reflecting elements of the RIS using the control information transmitted by the base station CU.

The base station may transmit signals to the terminal. When transmitting signals to the terminal, the base station may transmit the signals directly to the terminal. In other words, the base station DU may directly transmit the signals to the terminal. The base station may transmit signals to the RIS in order to transmit the signals to the terminal. The RIS may transmit the signal transmitted by the base station to the terminal.

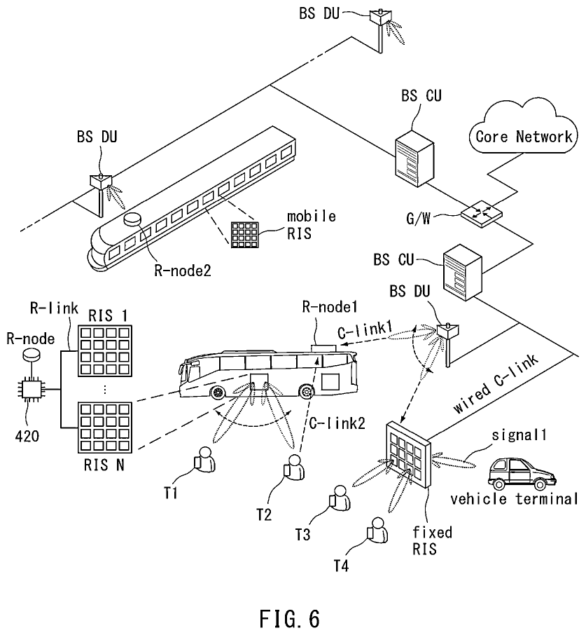

The RIS may be installed on an exterior wall of a building due to its ease of installation. Additionally, the RIS may be installed in moving objects such as buses and trains. The RIS may be installed in a moving object and connected to a vehicle terminal that communicates with the base station. The RIS installed in a moving object (e.g. vehicle terminal) may receive control information from the base station through a wireless C-link. The moving object in which the RIS is installed may include general vehicles, aircrafts, ships, satellites, high altitude platform stations (HAPSs), unmanned aerial vehicle (UAV), airplane, drone, and the like. The present disclosure proposes a mobile communication network using RISs installed in various moving objects. A multi-RIS-based mobile communication network through RISs installed in moving objects may be as shown in FIG. 6.

FIG. 6 is a conceptual diagram illustrating exemplary embodiments of a multi-RIS-based mobile communication network.

Referring to FIG. 6, a multi-RIS-based communication method in a mobile communication network may include at least one of a method in which a transmitting node transmits feedback information to a base station, a method in which the base station generates RIS control information based on the feedback information, a method in which the base station transmits the generated RIS control information, a method of controlling RIS node(s) based on the RIS control information, or a method in which the RIS node(s) reflect signals or the RIS node(s) allow signals to transmit through.

A receiving node may be a node capable of communicating with the transmitting node by establishing a communication link with the transmitting node. The receiving node may refer to a node that has a communication link established with the transmitting node, is located within a coverage of the transmitting node, and is capable of communicating with the transmitting node. In other words, the receiving node may refer to a node within a coverage of a control node (C-node). The receiving node may correspond to at least one of a terminal (e.g. UE) or a vehicle terminal. However, the receiving node may not be limited to a terminal or vehicle terminal. For example, if the C-node is the transmitting node, a terminal and/or an RIS-connected node (R-node) within the coverage of the C-node may be the receiving node. The receiving node may be referred to as a feedback node. In FIG. 6, the receiving nodes may be at least one of T1, T2, T3, or T4. T1 may refer to a terminal 1, T2 may refer to a terminal 2, T3 may refer to a terminal 3, and T4 may refer to a terminal 4.

The transmitting node may be at least one of the base station, C-node, or R-node. The base station may control the RIS node(s) through RIS control information. The base station may be at least one of the C-node or R-node.

The C-node (i.e. control node) may be an RIS control node. The C-node may directly control the RIS nodes. The C-node may indirectly control the RIS nodes.

The R-node may refer to an RIS-connected node. The RIS-connected node may be directly connected to the RIS node. The R-node may be a node that controls the RIS node according to control information received from the C-node. The R-node may perform at least one role of a transmitting node or a receiving node. The R-node may be referred to as a control node.

The C-link may refer to an RIS control link. The C-link may include a wired C-link and a wireless C-link. The C-link may refer to a wired/wireless link connecting the C-node and the R-node. Alternatively, the C-link may be a wired/wireless link connecting the RIS node and the C-node. The C-link may refer to a link that does not go through the R-node when connecting the RIS node and the C-node. In other words, the C-link may refer to a link that directly connects the RIS node and the C-node.

The R-link may refer to an RIS internal link. The R-link may refer to a wired or wireless link connecting the R-node and the RIS node.

In the multi-RIS-based mobile communication system using wireless or wired C-links, the C-links may include both wired C-links and wireless C-links. For example, the wireless C-links may include at least one of a C-link1 or C-link2. The wired C-link may be used when the base station CU (BS CU) and fixed RIS communicate. The wireless C-link may be used when the base station DU (BS DU) and an R-node1 communicate.

The R-node may be installed on at least one of a moving object or a fixed object. The R-node may be connected to one or more RIS nodes. The R-node may be classified into a mobile R-node or a fixed R-node. For example, the mobile R-node may include at least one of the R-node1 or R-node2. As described above, the RIS node may include an RIS controller. The RIS node may include RIS 1 to RIS N. In other words, the RIS node may include N RISs. N may be a natural number. The fixed RIS may reflect a signal transmitted by the base station DU (BS DU). The signal reflected by the RIS may be referred to as a signal1. The vehicle terminal may receive the signal1 reflected by the RIS.

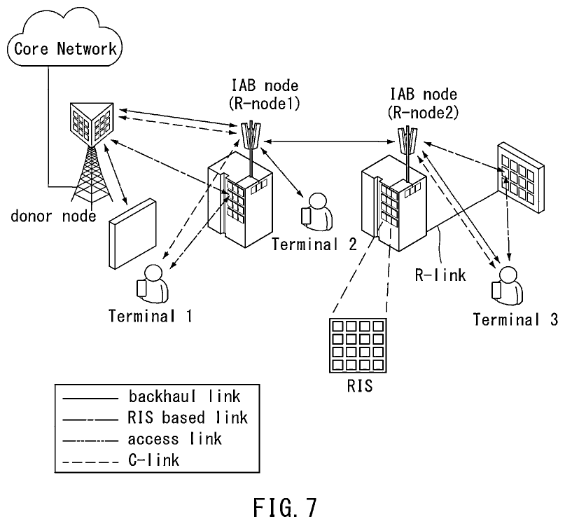

The mobile R-node may refer to an R-node installed on a moving object. The mobile R-node may be a vehicle terminal (e.g. V2X terminal) that performs communication with the base station or other terminals. The mobile R-node may be connected to one or more RIS nodes installed on the same moving object. For example, one mobile R-node (e.g. R-node1) may be installed on a bus. The one mobile R-node may be connected to a total of N RIS nodes installed on the bus. The fixed R-node (e.g. R-node2) may be as shown in FIG. 7.

FIG. 7 is a conceptual diagram illustrating exemplary embodiments of a multi-RIS-based mobile communication network.

Referring to FIG. 7, a fixed R-node may refer to an R-node installed on a fixed object. The fixed object may include a building, road structure (e.g. sign, traffic light, bridge), and the like. The fixed R-nodes may be IAB nodes of an IAB network. For example, the IAB nodes may include at least one of R-node1 or R-node2. The fixed R-nodes may be installed in various locations and serve as repeaters to relay signals from the base station or other terminals. The IAB nodes installed in buildings may serve as R-nodes. The fixed R-nodes may be installed on building walls and windows. The fixed R-nodes may be connected to multiple RIS nodes. The fixed R-node may be connected to one or more RIS nodes installed in the same location as the fixed R-node. The fixed R-node may be connected to one or more RIS nodes installed in a different location from the fixed R-node.

A core network may be connected to a donor node. The donor node may transmit and receive signals with a terminal 1 through an access link. The donor node may transmit and receive signals with the terminal 1 through an RIS-based link. The donor node may transmit and receive signals with the R-node1 through a backhaul link. The R-node1 may transmit and receive signals with the R-node2 through a backhaul link. The R-node1 may transmit and receive signals with the terminal 2 through an access link. The R-node2 may transmit and receive signals with the terminal 3 through an access link. The R-node2 may transmit and receive signals with the terminal 3 through a C-link 3. The R-node2 may transmit and receive signals with the terminal 3 through an RIS-based link. The RIS controller may transmit and receive signals with the RIS through an R-link.

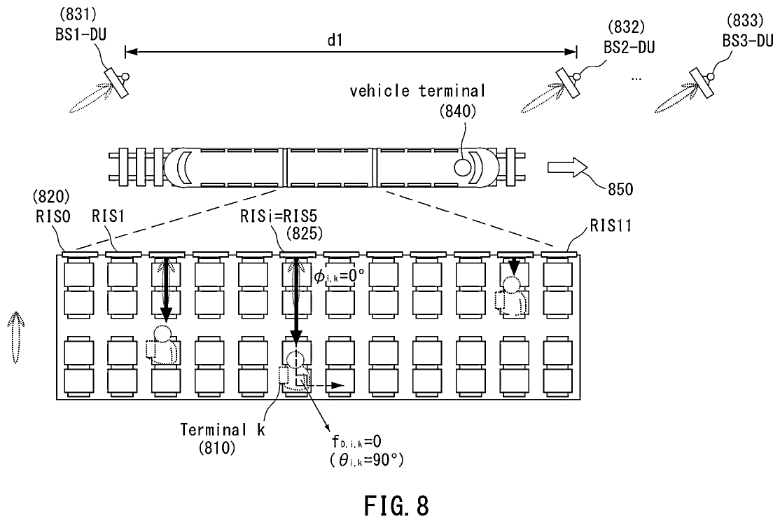

The multi-RIS-based mobile communication network may be as shown in FIG. 8.

FIG. 8 is a conceptual diagram illustrating exemplary embodiments of a multi-RIS-based communication method.

Referring to FIG. 8, in the case of a fixed RIS, control information exchange may be performed through a wired C-link connecting a base station and an RIS controller. In the case of a mobile RIS, exchanging control information through a wired C-link may be difficult. The present disclosure proposes a method for effectively controlling a mobile RIS in the mobile RIS-based wireless communication network. The method of controlling multiple mobile RISs may assume a communication scenario in a high-speed train (HST). The method of controlling multiple mobile RISs may be equally applicable to communication environments including various moving objects such as buses, passenger cars, aircraft, and ships. The method of controlling multiple mobile RISs may be equally applicable to communication environments based on multiple fixed RISs.

A receiving node (e.g. terminal or R-node) may measure channel state information (CSI) for each link. In other words, the terminal may measure CSI for each link, and generate feedback information. The R-node may measure CSI for each link, and generate feedback information. The CSI may include at least one of a channel quality indicator/indication (CQI), rank indication (RI), reference signal received power (RSRP), reference signal received quality (RSRQ), signal-to-noise ratio (SNR), or signal to interference plus noise ratio (SINR). The terminal may generate the feedback information including CSI, and transmit the feedback information to at least one of the R-node or C-node. The R-node may generate the feedback information including CSI, and transmit the feedback information to at least one of the terminal or C-node. The feedback information may be as follows.

The feedback information may include at least of CSI of an RIS-receiving node link, CSI of a C-node-RIS-receiving node link, a Doppler frequency shift/spreading value f_{D} for each RIS-receiving node link, or an angle θ between a movement direction of the receiving node and a signal received from the RIS.

The CSI of the RIS-receiving node link may refer to CSI of a link connected between an RIS 820 or 825 and a receiving node 810. For example, a terminal k 810 may generate CSIs for 12 links (RIS0-UE, RIS1-UE, . . . , and RIS11-UE) between the terminal k and the respective RIS nodes. The terminal k 810 may generate feedback information including CSIs for all or some of the 12 measured links. The CSIs included in the feedback information may be transmitted to the R-node. The terminal k 810 may generate feedback information including CSIs for all or some of the 12 measured links. The CSIs included in the feedback information may be transmitted to the C-node. The C-node may be at least one of a base station 1-DU (BS1-DU) 831, a base station 2-DU (BS2-DU) 832, or a base station 3-DU (BS3-DU) 833. The R-node may be a vehicle terminal 840. A distance between the base station 1-DU (BS1-DU) 831 and the base station 2-DU (BS2-DU) 832 may be referred to as d1.

The CSI of the C-node-RIS-receiving node link may refer to CSI of a link connecting the C-node 831, 832, or 833, each RIS, and receiving node. For example, the terminal k 810 may generate CSI for each of a link connecting the base station 1 831, each RIS, and terminal 810 (i.e. base station 1-RIS0-terminal, base station 1-RIS1-terminal, . . . , and base station 1-RIS11-terminal), a link connecting the base station 2 832, each RIS, and terminal 810 (i.e. base station 2-RIS0-terminal, base station 2-RIS1-terminal, . . . , and base station 2-RIS11-terminal), and a link connecting the base station 3 833, each RIS, and terminal 810 (i.e. base station 3-RIS0-terminal, base station 3-RIS1-terminal, . . . , and base station 3-RIS11-terminal). The terminal k 810 may transmit feedback information including CSIs for all or some of the 36 measured links to the R-node 840. The terminal k 810 may transmit feedback information including CSIs for all or some of the 36 measured links to the C-node 831.

The Doppler frequency shift/spreading value f_{D} for each RIS-receiving node link may refer to a Doppler frequency shift/spreading value for a link connecting the RIS and the terminal. For example, the terminal k 810 may measure the frequency shift/spreading values (i.e. f_{D,0,k}, f_{D,1,k}, . . . , f_{D,11,k}) for the 12 links between the terminal and the respective RIS nodes (i.e. RIS0-UE, RIS1-UE, . . . , and RIS11-UE). The terminal k 810 may generate feedback information including CSIs including all or some of the measured values, and transmit the feedback information to the R-node. The terminal k 810 may generate feedback information including CSIs including all or some of the measured values, and transmit the feedback information to the C-node.

A movement direction 850 of the receiving node for each RIS-receiving node link may refer a movement direction of the receiving node with respect to a link connecting each RIS and the terminal. The angle θ of the signal received from the RIS for each RIS-receiving node link may refer to an angle of the signal transmitted through the link connecting each RIS and the terminal. The terminal k 810 may measure the movement direction for each of the 12 links (RIS0-UE, RIS1-UE, . . . , and RIS11-UE) between the terminal and the respective RIS nodes. The terminal k 810 may measure angles (i.e. θ_{0,k}, θ_{1,k}, . . . , θ_{11,k}) for 12 links between the terminal and the respective RIS nodes (i.e. RIS0-UE, RIS1-UE, . . . , and RIS11-UE). The terminal k 810 may transmit feedback information including CSIs including all or some of the measured values to the R-node. The terminal k 810 may transmit feedback information including CSIs including all or some of the measured values to the C-node.

A terminal allocated or scheduled to be allocated an R-node that the C-node wishes to control may directly transmit feedback information to the C-node. Similarly, a terminal allocated or scheduled to be allocated an RIS node of the R-node may also transmit feedback information directly to the C-node. The terminal may transmit the feedback information directly through a C-link established with the C-node.

A terminal sharing the feedback information of the terminal allocated or scheduled to be allocated an R-node may transmit the feedback information to the C-node through a link (C-link). Similarly, a terminal sharing the feedback information of the terminal allocated or scheduled to be allocated an RIS node may transmit the feedback information to the C-node through a link (C-link).

If a feedback node is a receiving node of the C-node, the receiving node (e.g. terminal) may transmit feedback information to the C-node. In other words, the terminal may transmit CSI for each RIS node, which the terminal measures by receiving a reference signal transmitted by each RIS node, to the C-node. The CSI for each RIS node may include at least one of state information on a beam incident on the each RIS node, or state information on an output beam of the each RIS node.

The R-node may receive CSI required to control the RIS node from the RIS node through the R-link. The R-node may generate feedback information using the CSI transmitted by the RIS node. In addition, the R-node may receive feedback information transmitted by the receiving node. The R-node that the C-node wishes to control may transmit the feedback information to the C-node through the C-link. The feedback information transmitted by the R-node may include CSI for each RIS node of the R-node, which is collected from the terminal. The CSI for each RIS node collected by the R-node may include at least one of state information for an incident beam or output beam of the corresponding RIS node. The feedback information transmitted by the R-node may include RIS-system information (RIS-SI) generated by the R-node.

The R-node may generate the RIS-SI. The RIS-SI may include information on one or more RIS nodes connected to the R-node. The RIS nodes connected to the R-node may include activated RIS nodes. The RIS nodes connected to the R-node may include deactivated RIS nodes.

The RIS-SI may include at least one of information on the total number of the connected RIS nodes, location information of the connected RIS nodes, or state information (e.g. ON/OFF state) of the connected RIS nodes. The RIS-SI may include at least one of polarization state information or element-specific polarization state information of the connected RIS nodes. The RIS-SI may include current setting values for each element of the connected RIS nodes. The current setting values may indicate a phase and/or amplitude of each element. The RIS-SI may include information on a bit length for setting values for each element of the connected RIS node or information on a range of setting values for each element of the connected RIS node. The RIS node may configure the elements using the information on the bit length and range of setting values.

The RIS-SI may include sharing information for the connected RIS nodes. The sharing information of the connected RIS nodes may refer to information indicating whether each RIS node is shared with another R-node. For example, it may be announced that the k-th RIS node is shared with another R-node. If the k-th RIS node is a shared RIS node, sharing may be indicated by setting the k-th bit of the sharing information to 1.

The RIS-SI may include type information of the connected RIS nodes. The types of RIS nodes may include at least one of the following: reflection type, pass-through type, blocking type, reflection/pass-through integrated type, passive type, or active type. A blocking type RIS node may be one that prevents signal pass-through or signal reflection when a signal reaches the RIS. The individual elements of the RIS node may have different types according to the RIS-SI.

The RIS-SI may include information on frequency resources allocated to the connected RIS nodes. The frequency resource information may indicate a carrier, band width part (BWP), or resource blocks (RBs). The R-node may allocate the same or different frequency resources to the RIS nodes through the frequency resource information. The R-node may change the frequency resource information.

The RIS-SI may include information on continuous/non-continuous time resources allocated to the connected RIS nodes. The time resources may be indicated by at least one of frame number(s), slot number(s), or symbol number(s). The continuous time resources may be indicated using a start slot number and the length of slots. The R-node may allocate the same or different time resources to the RIS nodes through the time resource information. The R-node may change the time resource information. The R-node may allocate RIS nodes to the receiving node using the feedback information.

The RIS-SI may include information related to an incident signal/beam of the connected RIS node. The information related to the incident signal/beam may include information on an incident angle of the signal/beam and a beam width of the signal/beam.

The RIS-SI may include information related to a reception beam of an incident signal of the connected RIS node. The information related to the reception beam of the incident signal may include information on a set of reception beams for the incident signal, information on a set of output beams for each reception beam for the incident signal, information on the number of output beams, information on a beam width for each output bam, information on a direction of each output beam, or information on an angle of each output beam. The information related to the reception beam of the incident signal may include information on a reception direction of the incident signal, information on a set of angles for the incident signal, or information on a set of directions/angles of output signals for each direction/angle for the incident signal.

The RIS-SI may include information related to a transmission reference signal associated with the incident signal/beam of the connected RIS node. The RIS-SI may include information related to a transmission reference signal associated with the output signal/beam of the connected RIS node. The RIS-SI may include information related to a response reference signal associated with the incident signal/beam of the connected RIS node. The RIS-SI may include information related to a response reference signal associated with the output signal/beam of the connected RIS node.

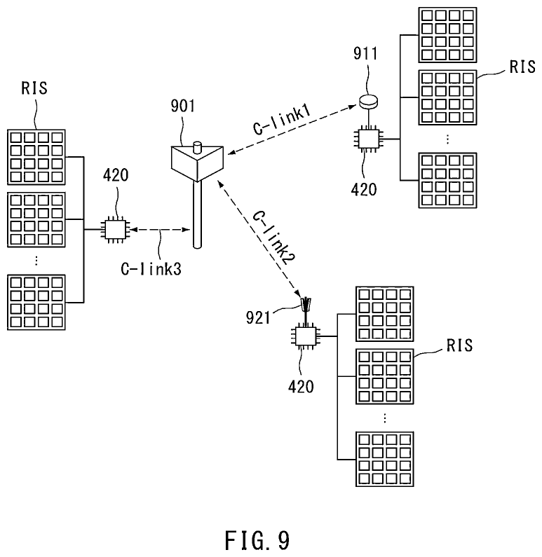

The base station may receive the feedback information transmitted by the terminal (e.g. receiving node) or R-node. The base station may generate RIS control information using the feedback information transmitted by the terminal. A method for the base station (e.g. C-node) to generate the RIS control information using the feedback information may be as shown in FIG. 9.

FIG. 9 is a conceptual diagram illustrating an exemplary embodiment of an RIS control information transmission method.

Referring to FIG. 9, the C-node may receive the feedback information transmitted by the receiving node. In addition, the C-node may receive the feedback information transmitted by the R-node. The C-node may generate RIS control information using the feedback information. The RIS control information may include information for controlling the RIS node connected to the R-node. The C-node may transmit the RIS control information to at least one of the R-node, RIS node, or RIS controller through the C-link. The C-node may allocate RIS(s) to the receiving node through the RIS control information. The C-link may include at least one of C-link1, C-link2, or C-link3.

A C-node 1 901 may receive feedback information from a mobile R-node1 911 through the wireless C-link 1. The C-node 1 901 may transmit control information generated using the feedback information to the R-node or RIS node.

The C-node 1 901 may receive feedback information from a mobile R-node2 921 through the wireless C-link 2. The C-node 1 901 may transmit control information generated using the feedback information to the R-node or RIS node.

The C-node 1 901 may be directly connected to the RIS node through the wireless C-link 3. The C-node 1 901 may directly control the RIS node.

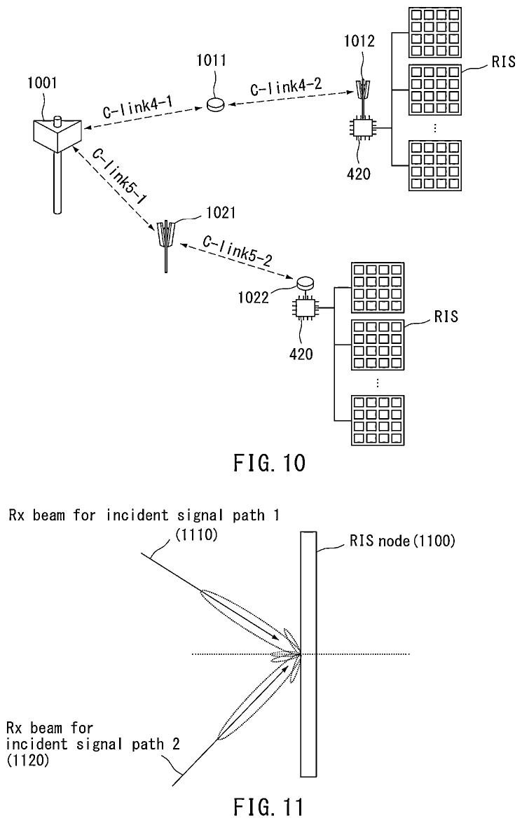

In the relay-based environment, a method for the base station (e.g. C-node) to generate the RIS control information using the feedback information may be as shown in FIG. 10.

FIG. 10 is a conceptual diagram illustrating an exemplary embodiment of an RIS control information transmission method.

Referring to FIG. 10, a C-node 2 1001 may receive feedback information from a fixed R-node3 through a mobile relay node 1011. In addition, the C-node 2 1001 may receive feedback information from a fixed R-node3 1012 through a wireless relay C-link 4 (i.e. C-link4-1, C-link4-2). The C-node 2 1001 may transmit the generated control information to the RIS node or R-node.

The C-node 2 1001 may receive feedback information from a mobile R-node2 1022 through a fixed relay node 1021. In addition, the C-node 2 1001 may receive feedback information from the mobile R-node2 1022 through a wireless relay C-link 5 (i.e. C-link5-1, C-link5-2). The C-node 2 1001 may transmit generated control information to the RIS node or R-node.

The control information generated by the C-node may be expressed as follows. The control information may include information for controlling the RIS node. The information for controlling the RIS node may include RIS node selection information or RIS allocation information. A method for the C-node to select the RIS node or a method for the C-node to allocate the RIS node may be as follows.

The receiving node may transmit feedback information required for allocating RIS(s) to at least one of the R-node or C-node. The receiving node may transmit feedback information required to control the RIS to at least one of the R-node or C-node. The feedback information may include channel information.

The receiving node may directly measure the channel information. The receiving node may select at least one of RIS nodes based on a result of the measurement performed by the receiving node itself. The receiving node may select at least one of RIS nodes based on the information transmitted by the R-node or C-node. The receiving node may transmit information on the selected RIS node(s) to the R-node and/or C-node. The R-node may receive the information on the RIS node(s) transmitted by the receiving node, and finally select RIS node(s) to be allocated to the receiving node. The R-node may receive the information on the RIS node(s) transmitted by the receiving node and finally allocate RIS node(s) to the receiving node. The C-node may receive the information on the RIS node(s) transmitted by the receiving node and finally select RIS node(s) to be allocated to the receiving node. The C-node may receive information on the RIS node(s) transmitted by the receiving node and finally allocate RIS node(s) to the receiving node. When the RIS node(s) are finally selected, the R-node and/or C-node may not apply the information on the RIS node(s) transmitted by the terminal.

The control information may include type information of RIS node(s) or mode information of RIS node(s). The control information may include information on a type of output signal of the RIS or a type of output beam of the RIS. In other words, the control information may include information on an output mode of the RIS node. The output mode information of the RIS node may include at least one of pass-through mode information, reflection mode information, suppression mode information, and simultaneous mode information. The reflection mode information may be information for outputting a signal incident on the RIS as a reflected output signal/beam. The pass-through mode information may be information for outputting a signal incident on the RIS as a pass-through type output signal/beam. The simultaneous mode information may be information for the RIS to output a reflection/pass-through integrated type output signal/beam obtained by simultaneously applying reflection and pass-through to the incident signal. The suppression mode information may be information for the RIS to output as a blocking output signal/beam obtained by blocking or suppressing reflection or pass-through of the incident signal. In other words, the suppression mode information may be information for preventing the RIS from reflecting a portion of the incident signal or allowing a portion of the incident signal to pass through. The RIS node may block and/or suppress a portion of the incident signal and transmit the remaining signal. The RIS node may output and/or generate various types of output signals/beams based on the incident signals by using the output mode information of the RIS node.

Referring again to FIG. 8, it may be assumed that there is the terminal k and 12 RIS nodes. The C-node and/or R-node may select RIS node(s) by which a direction of a beam passed through the terminal k is close to a threshold (e.g. 90 degrees or vertical), from among the 12 RIS nodes. In other words, if an angle φ_{i,k} between a surface of an RIS node and a beam passed through the RIS node is close to a threshold (e.g. 0 degrees), the C-node and/or R-node may allocate the RIS node to the receiving node. For example, among 12 RIS nodes, a direction of a beam passed through the RIS 5 825 toward the terminal k may be perpendicular to a surface of the RIS 5 825. In other words, among the 12 RIS nodes, 45 k value for the RIS 5 825 may be the smallest. The C-node and/or R-node may allocate the RIS 5 to the terminal k. Among the 12 RIS nodes, the RIS 4 and RIS 6 may have Pik values close to vertical. The C-node and/or R-node may allocate the RIS 4 and RIS 6 to the terminal k.

The C-node and/or R-node may allocate RIS node(s) based on frequency shift/spreading values f_{D,i,k} at the receiving node. In other words, the C-node and/or R-node may allocate to the terminal k RIS node(s) with a small frequency shift/spreading value at the receiving node among the 12 RIS nodes. For example, the C-node and/or R-node may allocate the RIS 5 825, for which f_{D,i,k} is 0, to the terminal k.

The C-node and/or R-node may allocate RIS node(s) to the terminal k based on a threshold (e.g. θ_{i,k}). θ_{i,k} may refer to an angle between a beam passed through toward the receiving node and a movement direction of the receiving node. The C-node and/or R-node may allocate one or more RIS nodes whose θ_{i,k} values are close to 90 degrees to the terminal k. The C-node and/or R-node may select one or more RIS nodes whose θ_{i,k} values are close to 90 degrees for the terminal k. For example, the C-node and/or R-node may allocate the RIS 5 825, whose θ_{i,k} value is 90 degrees, to the terminal k.

The C-node and/or R-node may allocate RIS node(s) to the terminal based on CSI for RIS nodes and the receiving node. The CSI may include at least one of CQI, RI, RSRP, RSRQ, SNR, or SINR. For example, the C-node and/or R-node may allocate one or more RIS nodes to the terminal based on RSRPs (e.g. RSRP_{0,k}, RSRP_{1,k}, . . . , RSRP_{11,k}) of links for the 12 RIS nodes measured by the receiving node. The C-node and/or R-node may allocation RIS node(s) whose RSRP values are greater than a specific threshold. If the RSRP values do not exceed the specific threshold, the C-node and/or R-node may allocate no RIS node. If the RSRP values do not exceed the specific threshold, the C-node and/or R-node may directly communicate with the terminal or postpone communication with the terminal.

The C-node and/or R-node may allocate RIS node(s) based on CSI for a C-node-RIS node-receiving node link (i.e. a link connecting the C-node, the RIS node, and the receiving node) to the terminal. The C-node may be the base station 832 or base station 833. For example, the C-node and/or R-node may allocate one or more RIS nodes to the terminal k based on RSRP values for 12 C-node 832-RIS node-receiving node links measured by the receiving node and RSRP values for 12 C-node 833-RIS node-receiving node links measured by the receiving node. The RSRPs for the 12 C-node 832-RIS node-receiving node links may be expressed as RSRP_{2,0,k}, RSRP_{2,1,k}, . . . , RSRP_{2,11,k}. The RSRPs for the 12 C-node 833-RIS node-receiving node links may be expressed as RSRP_{3,0,k}, RSRP_{3,1,k}, . . . , RSRP_{3,11,k}.

For example, when the terminal k is allocated RIS node(s) while communicating with the base station 2 832, which is a serving base station, the R-node and C-node may allocate RIS node(s) based on the RSRP values for the base station 2 832-RIS node-receiving node links. The R-node may be the vehicle terminal 840. The C-node may be the base station 3 833.

The base stations 832 and 833 may update the serving base station based on the RSRP values. In other words, the serving base station may be changed based on the RSRPs for the 12 C-node 832-RIS node-receiving node links and the RSRPs for the 12 C-node 833-RIS node-receiving node links. If Equation 1 below is maintained for a certain period of time, the serving base station may be changed from the base station 2 832 to the base station 3 833. Equation 1 may be as follows.

F(RSRP_{2,0,k}, RSRP_{2,1,k}, . . . , RSRP_{2,11,k})<F(RSRP_{3,0,k}, RSRP_{3,1,k}, . . . , RSRP_{3,11,k})+OFFSET [Equation 1]

F(·) may include at least one of min (·), max (·), median (·), sum (·), or average (·). average (·) may correspond to various averaging schemes such as weighted averaging. OFFSET may be set by a higher layer message such as RRC signaling. ‘<’ may be changed to ‘≤’.

The base station may generate control information including allocation information of RIS node(s). The base station may transmit all or part of the control information to the receiving node. In addition, the base station may transmit all or part of the control information to the R-node. As a method for the base station to transmit the control information to the R-node, a method similar to the above-described method for the R-node to transmit RIS-SI to the receiving node may be used. In other words, the base station may transmit the control information to the R-node using a method similar to the method in which the R-node transmits RIS-SI to the receiving node. The method by which the base station transmits the control information to the R-node may not be limited.

The base station (e.g. C-node) may transmit the control information to the R-node through the C-link. The control information may include RIS node set information. The RIS node set information may be expressed as 22. The RIS node set information may include RIS node information consisting of one or more RIS nodes that the base station wishes to control.

For example, the C-node may transmit, to each R-node, the RIS node set information (Ω={1,2,5}) consisting of RIS nodes 1, 2, and 5 among 10 RIS nodes connected to the R-node. The C-node may transmit the RIS node set information to the RIS node or receiving node.

The control information may include detailed control information for each RIS node belonging to the RIS node set Ω. The control information may include at least one of output mode information of the RIS node, information on the RIS node(s) allocated to the receiving node, or resource allocation information.

The output mode information of the RIS node may mean information on a mode in which the RIS node allows an incident signal to pass through, or reflects, or blocks the incident signal. The output mode information of the RIS node may include at least one of pass-through mode information, reflection mode information, blocking mode information, or simultaneous mode information. The pass-through mode information or reflection mode information may include a transmittance α and a reflectance β.

The simultaneous mode information may include both of a transmittance and a reflectance. For example, if the RIS node allows a half of incident radio waves to pass through and reflects the other half, the base station may transmit information on a transmittance α=0.5 and a reflectance β=0.5 to the R-node or RIS node. When the RIS node allows a half of the incident radio waves to pass through and reflects the other half, the base station may predefine that a sum of the transmittance and reflectance is 1. If the RIS node allows a half of the incident radio waves to pass through and reflects the other half, the base station may transmit only information on a transmittance α=0.5 to the R-node or RIS node. The R-node or RIS node may calculate a reflectance (β=1−α) using the transmittance informed by the base station.

The information on the RIS node(s) allocated to the receiving node, which is transmitted to the receiving node, may indicate that each RIS node is allocated to one or more receiving nodes. The resource allocation information may be transmitted to the RIS node or receiving node. The resource allocation information may include at least one of frequency resource information or time resource information. The frequency resource information may indicate at least one of a carrier, BWP, or RBs. The time resource may be indicated by at least one of frame number(s), slot number(s), or symbol number(s). The base station may allocate resources to the RIS node or receiving node through the resource allocation information.

For example, the RIS node set information may include an RIS node 1 and RIS node 2. The RIS node set may be expressed as ω={1,2}. The base station may use the RIS node 1 included in the RIS node set to communicate with the terminal 1. The base station may transmit resource allocation information to the RIS node 1 and terminal 1 in order to communicate with the terminal 1. The resource allocation information for the RIS node 1 and terminal 1 may indicate a first carrier, a first BWP within the first carrier, or slots 0 to 19 of the first carrier.

The base station may use the RIS node 1 included in the RIS node set to communicate with the terminal 2. The resource allocation information for the RIS node 1 and the terminal 2 may indicate the first carrier, the first BWP within the first carrier, or slots 20 to 39 of the first carrier.

The base station may use the RIS node 2 included in the RIS node set to communicate with the terminal 3. The resource allocation information for the RIS node 2 and the terminal 1 may indicate a second carrier, a first BWP within the second carrier, or slots 0 to 19 of the second carrier.

The base station may use the RIS node 2 included in the RIS node set information to communicate with the terminal 4. The resource allocation information for the RIS node 2 and the terminal 2 may indicate the second carrier number, a second BWP within the second carrier, or slots 0 to 19 of the second carrier.

The control information may include at least one of reception beam set information or output beam set information. The reception beam set information may refer to information on a set of beams for incident signals received by the RIS node. The output beam set information may refer to information on a set of beams for output signals transmitted by the RIS node. The control information may include at least one of reception direction set information or reception angle set information. The reception direction set information may refer to information on a set of reception directions for incident signals received by the RIS node. The reception angle set information may refer to information on a set of reception angles for incident signals received by the RIS node.

The control information may include at least one of output direction set information or output angle set information. The output direction set information may refer to information on a set of output directions for signals output by the RIS node. The output angle set information may refer to information on a set of output angles for signals output by the RIS node.

The beam set information included in the control information may be as shown in FIG. 11.

FIG. 11 is a conceptual diagram illustrating an exemplary embodiment of beam sets for an RIS node.

Referring to FIG. 11, the C-node may use signals of two directions to communicate with the receiving node. The C-node may configure a beam set to the RIS node so that the RIS node receives incident signals in two directions. The RIS node may receive beam set information transmitted by the base station. The RIS node may receive incident signals in two directions based on the beam set information. The RIS node may receive a set of beams incident in two directions based on the beam set information. In other words, the RIS node 1100 may receive an Rx beam 1110 for an incident signal path 1. The Rx beam for the incident signal path 1 may belong to a beam set transmitted through the incident signal path 1. The RIS node 1100 may receive an Rx beam 1120 for an incident signal path 2. The Rx beam for the incident signal path 2 may belong to a beam set transmitted through the incident signal path 2. The Rx beam may include at least one signal. The Rx beam 1110 for the incident signal path 1 and the Rx beam 1120 for the incident signal path 2 may be transmitted in different directions.

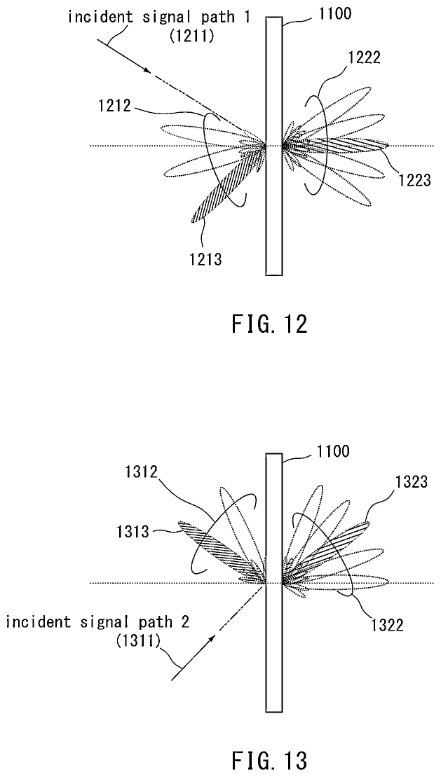

The Rx beams in two directions may be associated with one or more output beams output from the RIS node. The output beam may refer to a beam reflected by the RIS node or a beam passed through the RIS node. In other words, the RIS node may receive the incident signals coming from different directions. The RIS node may transmit the Rx beams coming from different directions as at least one output beam. A method by which the RIS node transmits the Rx beams as at least one output beam may be as shown in FIG. 12.

FIG. 12 is a conceptual diagram illustrating an exemplary embodiment of beam sets for an RIS node.

Referring to FIG. 12, when the RIS node uses the reflection function, the RIS node may receive an Rx beam through an incident signal path 1 1211. The RIS node may reflect the Rx beam. The RIS node may output a beam set 1 1212 by reflecting the Rx beam. In other words, the RIS node may form at least one output beam by reflecting the Rx beam. The at least one output beam may form the beam set 1 1212. For example, the reflection path/beam set 1 1212 may include three output beams. The output beams of the reflection path/beam set 1 1212 may be transmitted in three paths. At least one output beam output from the RIS node may have different reflection paths. The reflection beam set 1 1212 formed of at least one output beam may be configured by the C-node. The C-node may configure the reception beam (e.g. Rx beam) and the reflection beam set 1 1212 formed by the reception beam as downlink beams. The terminal may select a beam from the beam set 1 1212 reflected by the RIS node 1213.

If the RIS node uses the pass-through function, the RIS node may receive an Rx beam through the incident signal path 1 1211. The RIS node may allow the Rx beam to pass through. The RIS node may output a beam set 1 1222 by allowing the Rx beam to pass through. In other words, the RIS node may form at least one output beam by allowing the Rx beam to pass through. The at least one output beam may form the beam set 1 1222. A pass-through path/beam set 1 1222 may include five output beams. The output beams of the transmission path/beam set 1 1222 may be transmitted in five paths. The at least one output beam output from the RIS node may have different pass-through paths. The pass-through beam set 1 1222 composed of the at least one output beam may be configured by the C-node. The C-node may configure the reception beam (e.g. Rx beam) and the pass-through beam set 1 1222 formed by the reception beam as downlink beams. The terminal may select at least one beam from the pass-through path/beam set 1 1222 transmitted by the RIS node 1223. A method of outputting the output beam(s) by allowing the Rx beam received by the RIS node to transmit through may be as shown in FIG. 12.

FIG. 13 is a conceptual diagram illustrating an exemplary embodiment of beam sets for an RIS node.

Referring to FIG. 13, when the RIS node uses the reflection function, the RIS node may receive an Rx beam through an incident signal path 2 1311. The RIS node may reflect the Rx beam. The RIS node may output a beam set 2 1312 by reflecting the Rx beam. In other words, the RIS node may form at least one output beam by reflecting the Rx beam. The at least one output beam may form the beam set 2 1312. At least one output beam output from the RIS node may have different reflection paths. The reflection beam set 2 1312 formed of at least one output beam may be configured by the C-node. The C-node may configure the reception beam (e.g. Rx beam) and the reflection beam set 2 1312 formed by the reception beam as uplink beams. The terminal may select a beam from the beam set 2 1312 reflected by the RIS node.

If the RIS node uses the pass-through function, the RIS node may receive an Rx beam through the incident signal path 2 1311. The RIS node may allow the Rx beam to pass through. The RIS node may output a beam set 2 1322 by allowing the Rx beam to pass through. In other words, the RIS node may form at least one output beam by allowing the Rx beam to pass through. The at least one output beam may form the beam set 2 1322. The at least one output beam output from the RIS node may have different pass-through paths. The pass-through beam set 2 1322 composed of the at least one output beam may be configured by the C-node. The C-node may configure the reception beam (e.g. Rx beam) and the pass-through beam set 2 1322 formed by the reception beam as uplink beams. The terminal may select at least one beam from the pass-through path/beam set 2 1322 transmitted by the RIS node.

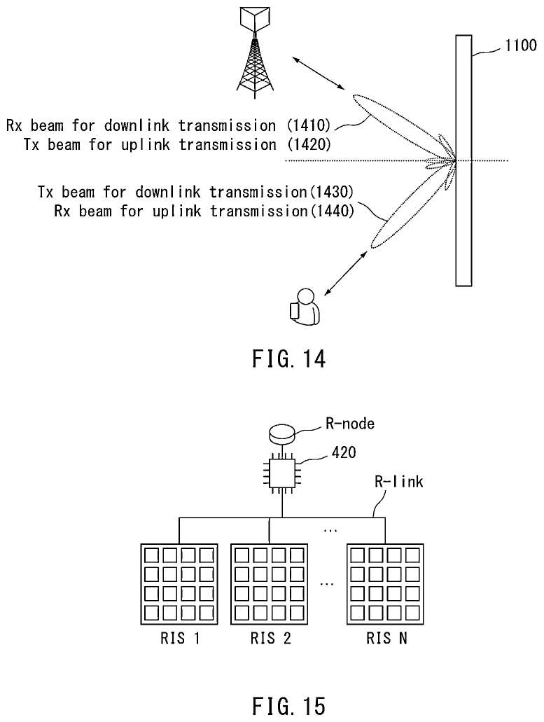

The control information may include at least one of reception beam information or output beam information. The reception beam information or output beam information may be as shown in FIG. 14.

FIG. 14 is a conceptual diagram illustrating an exemplary embodiment of beam correspondence for an RIS node.

Referring to FIG. 14, a reception beam may refer to a beam transmitted by the base station and received by the RIS node. The reception beam may refer to a beam that the base station and the terminal are to use for communication. The reception beam may refer to a beam that the base station and the terminal are using for communication. An output beam may refer to a beam output by the RIS node.

The C-node may transmit signals in a direction of the receiving node through an RIS node belonging to an RIS node set Ω. For example, this may correspond to a case where the base station (i.e. C-node) performs downlink communication with the terminal through the RIS node. When transmitting an incident signal (e.g. downlink incident signal) to the RIS node, the C-node may transmit information on a reception beam used for the incident signal to the RIS node. When transmitting an incident signal (e.g. downlink incident signal) to the RIS node, the C-node may transmit information on one or more output beams for the incident signal to the RIS node. The output beam may be a downlink output beam.

The C-node may receive a signal of the receiving node through the RIS node belonging to the RIS node set Ω. For example, the base station (i.e. C-node) may perform uplink communication with the terminal through the RIS node. The C-node may transmit information on a reception beam used for an incident signal (e.g. uplink incident signal) used for communicating with the terminal to the RIS node. The C-node may transmit information on one or more output beams for the reception beam to the RIS node. The output beam may be an uplink output beam.

The C-node may apply beam correspondence using the reception beam and output beam of the RIS node belonging to the RIS node set Ω. In other words, when performing downlink and uplink communication via the RIS node, the base station and the terminal may apply beam correspondence to an Rx beam 1410 for downlink transmission and a Tx beam 1420 for uplink transmission. When performing downlink and uplink communication via the RIS node, the base station and the terminal may apply beam correspondence to an Rx beam 1440 for uplink transmission and a Tx beam 1430 for downlink transmission.

Meanwhile, the control information may include state information of the RIS node. The control information may include state information for each reflecting element of the RIS node. The state information may include ON/OFF state information.

The control information may include polarization state information of the received signal and/or the reception beam. The control information may include polarization state information of the output signal and/or output beam. The polarization state information may include at least information for adjusting an angle of a polarization direction. For example, the C-node may adjust a polarization direction of the received signal and/or reception beam of the RIS node. The C-node may adjust a polarization direction of the output signal and/or output beam of the RIS node. When the C-node adjusts the polarization direction of the signal and/or beam, the RIS node may improve a reception strength of the signal and/or beam when transmitting the signal and/or beam by reflecting the incident signal and/or beam or by allowing the incident signal and/or beam to pass through.

Referring again to FIG. 8, the C-node may transmit RIS-SI rather than the control information. The C-node may transmit master RIS-SI to the receiving node. The master RIS-SI may include RIS-SI^{(C)} and RIS-SI^{(R)}. RIS-SI^{(C)} may refer to RIS-SI for an RIS node directly connected to the C-node. RIS-SIₖ^{(R)} may refer to RIS-SI for one or more R-nodes managed by the C-node. In RIS-SIₖ^{(R)}, k may indicate an index of the R-node.

In the master RIS-SI, RIS-SI^{(C)} may include information on RIS-SIₖ^{(R)} The master RIS-SI may include information on the number of R-nodes (N_{R-node}), type information of the R-nodes, information on the maximum number of R-nodes allocatable to each receiving node, or information on the maximum number of RIS nodes allocatable to each receiving node.

When an RIS node is directly connected to a C-node, the C-node may be regarded as an R-node, and the C-node may be counted as an R-node and included in N_{R-node}. For example, when an RIS node is directly connected to a C-node without using an R-node, the C-node may be regarded one R-node. When an RIS node is directly connected to a C-node without using an R-node, the C-node may be included in the number of R-nodes NR-node. Alternately, when an RIS node is directly connected to a C-node without using an R-node, the C-node may not be included in the number of R-nodes N_{R-node}.

The type information of the R-node may include at least one of mobile-type, fixed-type, directly-connected-type, or indirectly-connected-type. A mobile R-node may correspond to a case where the R-node is installed on a moving object and has mobility. A fixed R-node may correspond to a case where the R-node is installed in a fixed object and does not have mobility. A directly-connected R-node may correspond to a case where the RIS node is directly connected to the C-node without using an R-node. An indirectly-connected R-node may correspond to a case where the RIS node is connected to the C-node via an R-node.

The C-node may generate RIS-SI^{(C)}. The C-node may generate master RIS-SI. For example, when receiving RIS-SI₁^{(R)} and RIS-SI₂^{(R)} from two R-nodes managed by the C-node through the C-link, the C-node may configure the master RIS-SI as Master_RIS_SI={N_{R-node}, RIS-SI^{(C)}, RIS-SI₁^{(R)}, RIS-SI₂^{(R)}}.

The C-node may transmit the master RIS-SI to the receiving node. As a method by which the C-node transmits the master RIS-SI to the receiving node, a method similar to the method by which the R-node transmits RIS-SI to the receiving node may be used.

The R-node may transmit RIS-SI to the receiving node within a coverage of the R-node. When a downlink is established between the R-node and the receiving node (e.g. terminal), the R-node may transmit RIS-SI to the receiving node through the downlink. When an uplink is established between the R-node and the receiving node (e.g. terminal), the R-node may transmit RIS-SI to the receiving node through the uplink. The R-node may transmit RIS-SI through DL control information (DCI) included in a physical DL control channel (PDCCH). Alternatively, the R-node may transmit RIS-SI through UL control information (UCI) included in a physical UL control channel (PUCCH). Alternatively, the R-node may transmit RIS-SI through RRC signaling on a Uu link. The R-node may transmit RIS-SI through a MAC CE on the Uu link.

When a sidelink (SL) is established between the R-node and the receiving node (e.g. terminal), the R-node may transmit RIS-SI to the receiving node through the sidelink. The R-node may transmit RIS-SI through SL control Information (SCI) included in a physical SL control channel (PSCCH). Alternatively, the R-node may transmit RIS-SI through RRC signaling on a PC5 link. Alternatively, the R-node may transmit RIS-SI through a MAC CE on the PC5 link.

When a link is not established between the R-node and the receiving node (e.g. terminal), the R-node may transmit RIS-SI to the terminal through a downlink synchronization signal block (SSB). The SSB may include at least one of primary synchronization signal (PSS), secondary synchronization signal (SSS), or physical sidelink broadcast channel (PSBCH). When a link is not established between the R-node and the receiving node (e.g. terminal), the R-node may transmit RIS-SI to the terminal through an SL-SSB. The SL-SSB may include at least one of PSS, SSS, or PSBCH.

Meanwhile, the RIS node may be composed of one or more reflecting elements. The RIS node may group the reflecting elements into one or more groups, and each group may operate as an independent RIS node. For example, if the RIS node consists of 100 reflecting elements, the RIS node may configure a group with 80 reflecting elements, and the group may be used as an independent RIS node. Alternatively, if the RIS node consists of 100 reflecting elements, the RIS node may configure two independent groups by grouping 50 reflective elements. The two independent groups may be composed of reflecting elements that do not overlap each other.

If the RIS node consists of 100 reflecting elements, the RIS node may form a group 1 by grouping 80 reflecting elements. In this case, the RIS node may form a group 2 by grouping 50 reflecting elements. The group 1 and the group 2 may share 30 reflecting elements.

When an incident signal and/or beam is received by the RIS node, the RIS node may generate output signals and/or beams in one or more directions. Alternatively, when an incident signal and/or beam is received by the RIS node, the RIS node may block output signals and/or beams in one or more directions. For example, the RIS node may reflect a signal and/or beam incident on the RIS node in one or more directions. The RIS node may allow a signal and/or beam incident on the RIS node to pass through the RIS node in one or more directions. The RIS node may reflect a signal and/or beam incident on the RIS node and/or allow the signal and/or beam to pass through the RIS node in one or more directions. The RIS node may block signals and/or beams output from the RIS node from being reflected in one or more directions. The RIS node may block signals and/or beams output from the RIS node from being transmitted through the RIS node in one or more directions.

The RIS node may receive control information from the R-node to control the reflecting elements of the RIS node. The RIS node may be connected to the R-node to receive the control information.

The R-node may be connected to one or more RIS nodes through R-link(s) and RIS controller(s). The R-node may control the RIS node(s) according to control information received from the respective C-nodes using the RIS controller(s). The R-link(s) may include wired or wireless link(s). The R-node may directly control the RIS node(s) connected to it without control of the C-node. The R-node may be regarded as a C-node. The R-link may be regarded as a C-link.

The R-node may control the RIS node(s) as follows. The R-node may control the RIS node(s) using feedback information (e.g. channel information) collected from network nodes (e.g. base station and/or terminal) that communicate with the R-node. The R-node may control connected RIS node(s) according to control information received from the C-node. A method by which the RIS node and the R-node are connected may be as shown in FIG. 15.

FIG. 15 is a conceptual diagram illustrating exemplary embodiments of connections between RIS nodes and base station.

Referring to FIG. 15, the R-node may be installed on a moving object or fixed object. The R-node may be connected to one or more RISs. For example, the R-node may be connected to one RIS controller. The RIS controller may simultaneously control the RISs according to control information received from the R-node.

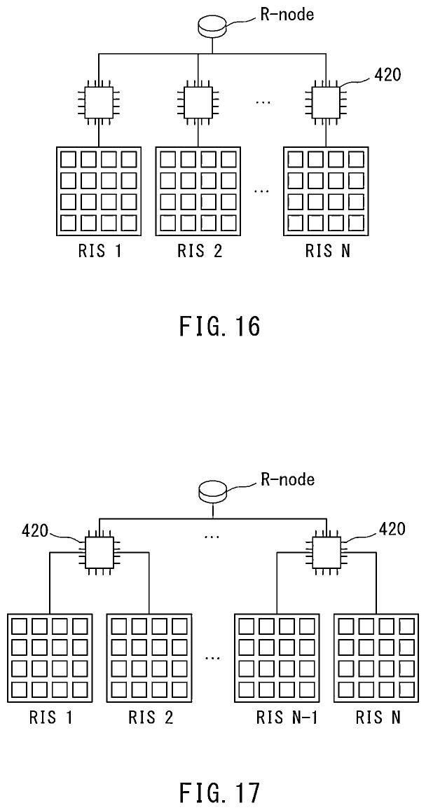

FIG. 16 is a conceptual diagram illustrating exemplary embodiments of connections between RIS nodes and base station.

Referring to FIG. 16, the R-node may be connected to one or more RIS controllers. For example, the R-node may be connected to at least one RIS controller. Each RIS controller may control one RIS according to control information received from the R-node. In other words, one RIS controller may be connected to one RIS. The R-node may control the RISs connected to the R-nodes simultaneously or independently.

FIG. 17 is a conceptual diagram illustrating exemplary embodiments of connections between RIS nodes and base station.

Referring to FIG. 17, the R-node may be connected to at least one RIS controller. The RIS controller may be connected to at least one RIS. For example, the R-node may be connected to at least one RIS controller. The RIS controller may control at least one RIS according to control information received from the R-node. For example, the R-node may be connected to two RIS controllers. The RIS controller may be connected to two RISs.

FIG. 18 is a conceptual diagram illustrating exemplary embodiments of connections between RIS nodes and base station.

Referring to FIG. 18, at least one R-node may be connected to at least one RIS controller. The RIS controller may be connected to at least one RIS. For example, an R-node1 may be connected to at least one RIS controller. The RIS controller may be connected to K RISs. An R-node2 may be connected to at least one RIS controller. The RIS controller may be connected to (N-K) RISs.

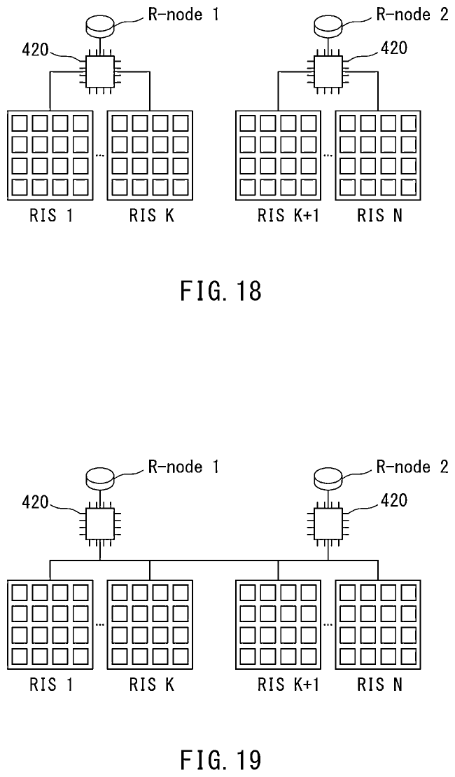

FIG. 19 is a conceptual diagram illustrating exemplary embodiments of connections between RIS nodes and base station.

Referring to FIG. 19, at least one R-node may be connected to at least one RIS controller. The RIS controller may be connected to at least one RIS. The R-nodes may share at least one RIS. For example, an R-node1 may be connected to at least one RIS controller. The RIS controller may be connected to K RISs. An R-node2 may be connected to at least one RIS controller. The RIS controller may be connected to (N-K) RISs. The R-node1 and R-node2 may share the (K+1)-th RIS node.

A vehicle terminal may perform a role of the R-node. The vehicle terminal may be installed inside or outside a high-speed train. The vehicle terminal may be connected to 12 mobile RISs. The mobile RIS may be installed on an exterior wall or window of the HST. The vehicle terminal may control each RIS directly connected to the vehicle terminal. The vehicle terminal may control each RIS connected to the vehicle terminal according to control of the base station. When a radio wave transmitted by the base station is transmitted to the receiving node, the R-node (e.g. vehicle terminal) may reduce signal attenuation that occurs when the radio wave transmitted by the base station passes through the exterior wall of the HST.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a reconfigurable intelligent surface (RIS) node, comprising:
receiving, from a first transmitting node, control information for controlling the first RIS node;
grouping reflecting elements of the first RIS node into at least one reflecting element group using the control information; and
transmitting at least one signal incident on the at least one reflecting element group to a receiving node.

2. The method according to claim 1, wherein the receiving of the control information for controlling the first RIS node comprises: receiving the control information from a first node receiving the control information from the first transmitting node,
wherein the first node includes at least one of a fixed network node or a mobile network node.

3. The method according to claim 1, wherein the grouping of the reflecting elements of the first RIS node comprises: grouping the reflecting elements of the first RIS node into reflecting element groups sharing at least one reflecting element of the first RIS node.

4. The method according to claim 1, wherein the transmitting of the at least one signal comprises: transmitting the at least one signal to the receiving node by performing at least one of reflection, pass-through, or suppression in at least one direction.

5. The method according to claim 1, wherein the transmitting of the at least one signal comprises:
receiving signals having different directions; and
transmitting the signals to the receiving node by outputting the signals as at least one of a reflection beam set, a pass-through beam set, or a suppression beam set,
wherein the reflection beam set includes at least one reflected beam, the pass-through beam set includes at least one beam passed through the at least one RIS node, and the suppression beam set includes at least one beam generated by blocking or suppressing reflection or pass-through of at least portion of the at least one signal.

6. A method of a base station, comprising:
receiving, from a receiving node, feedback information including channel state information;
determining at least one reconfigurable intelligent surface (RIS) node allocated to the receiving node, based on the channel state information included in the feedback information;
generating grouping information indicating to group reflecting elements of the at least one RIS node into at least one reflecting element group, based on the channel state information included in the feedback information;
generating control information including at least one of the grouping information or information for configuring the at least one RIS node; and
controlling the at least one RIS node by transmitting the control information.

7. The method according to claim 6, wherein the determining of the at least one RIS node comprises: determining the at least one RIS node allocated to the receiving node based on whether an angle between a surface of the at least one RIS node and a signal received by the receiving node is less than a threshold.

8. The method according to claim 6, wherein the determining of the at least one RIS node comprises: determining the at least one RIS node allocated to the receiving node based on whether at least one of a frequency shift or spreading value between the at least one RIS node and the receiving node is less than a threshold.

9. The method according to claim 6, wherein the determining of the at least one RIS node comprises: determining the at least one RIS node allocated to the receiving node based on whether a quality of a signal received by the receiving node is less than a threshold.

10. The method according to claim 6, wherein the control information includes information for applying at least one of reflection, pass-through, or suppression to a signal incident on the at least one RIS node in at least one direction.

11. The method according to claim 6,
wherein the control information includes at least one of information on an RIS node set used for configuring the at least one RIS node, output mode information of the at least one RIS node, information on a transmittance of the at least one RIS node, information on a reflectance of the at least one RIS node, state information of the at least one RIS node, state information of each reflecting element of the at least one RIS node, information on a set of reception beams incident on the at least one RIS node, or information on a set of output beams output by the at least one RIS node, and
wherein the output mode information of the at least one RIS node includes at least one of pass-through mode information, reflection mode information, suppression mode information, and simultaneous mode information, and the information on the set of reception beams includes at least one of information on a set of reception directions for an incident signal or information on a set of angles of the incident signal, and the information on the set of output beams includes at least one of information on a set of output directions or information on a set of output angles.

12. The method according to claim 11, wherein the information on the set of output beams includes information on at least one output beam set associated with at least one signal among incident signals, and output beam sets associated with different incident signals included in the incident signals are different from or same as each other.

13. A reconfigurable intelligent surface (RIS) node comprising: at least one processor, wherein the at least one processor causes the first RIS node to perform:
receiving, from a first transmitting node, control information for controlling the first RIS node;
grouping reflecting elements of the first RIS node into at least one reflecting element group using the control information; and
transmitting at least one signal incident on the at least one reflecting element group to a receiving node.

14. The RIS node according to claim 13, wherein in the receiving of the control information for controlling the first RIS node, the at least one processor further causes the first RIS node to perform: receiving the control information from a first node receiving the control information from the first transmitting node, wherein the first node includes at least one of a fixed network node or a mobile network node.

15. The RIS node according to claim 13, wherein in the grouping of the reflecting elements of the first RIS node, the at least one processor further causes the first RIS node to perform: grouping the reflecting elements of the first RIS node into reflecting element groups sharing at least one reflecting element of the first RIS node.

16. The RIS node according to claim 13, wherein in the transmitting of the at least one signal, the at least one processor further causes the first RIS node to perform: transmitting the at least one signal to the receiving node by performing at least one of reflection, pass-through, or suppression in at least one direction.

17. The RIS node according to claim 13, wherein in the transmitting of the at least one signal, the at least one processor further causes the first RIS node to perform: receiving signals having different directions; and transmitting the signals to the receiving node by outputting the signals as at least one of a reflection beam set, a pass-through beam set, or a suppression beam set, and
wherein the reflection beam set includes at least one reflected beam, the pass-through beam set includes at least one beam passed through the at least one RIS node, and the suppression beam set includes at least one beam generated by blocking or suppressing reflection or pass-through of at least portion of the at least one signal.
